(19) United States
(12) Patent Application Publication
(10) Pub. No.: US 2021/0348591 A1
(43) Pub. Date: Nov. 11, 2021

(54) Rotor Blade of a Wind Power Plant with a Particle Damping Device and Method for Producing Same

(71) Applicant: Senvion GmbH, Hamburg (DE)

(72) Inventors: Lukas MATHIS, Kronshagen (DE); Francesco PREVITALI, Hamburg (DE)

(21) Appl. No.: 17/284,084

(22) PCT Filed: Oct. 7, 2019
(86) PCT No.: PCT/EP2019/077109

§ 371 Date: Apr. 9, 2021

(30) Foreign Application Priority Data
Oct. 9, 2018 (DE) 10 2018 007 953.9

(51) Int. Cl. F03D 1/06; F16F 7/01

(52) U.S. Cl. CPC F03D 1/0675; F16F 7/01; F16F 2222/04; F05B 2260/964; F05B 2250/283

(57) ABSTRACT

A rotor blade of a wind turbine with a particle damping device having at least one cavity (3) with inner walls (4) delimiting an interior and with a medium arranged in the interior so as to be movable with respect to the inner walls (4). Additionally, a rotor blade is provided with a vibration-damping mechanism, and a method for manufacture of such a rotor blade.

The invention concerns a motor blade of a wind turbine. The invention also concerns a method for manufacture of a rotor blade of a wind turbine.

Rotor blades for wind turbines have naturally been known for a long time in the prior art.

Rotor blades of modern wind turbines are becoming ever longer and more slender. This leads to problems, in particular with respect to their vibration behaviour; the longer the rotor blades become, the more critical their vibration effects. Vibrations affect the dimensioning of the rotor blade since, for example, load changes can lead to material fatigue and even to fatigue breaks.

In order to meet prescribed service life lengths, the supporting structures of the rotor blade must accordingly be dimensioned thicker and heavier.

In comparison with the aerodynamic damping in the flap direction of the rotor blade, the aerodynamic damping in the edge direction is slight because of the small cross-sectional area perpendicularly to the edge direction. It is therefore desirable if a high structural damping is present in particular in the edge direction.

Normally, loads on the rotor blade resulting from vibration are reduced by the use of structural materials.

The use of stabilising structural materials increases the mass of the rotor blade, whereby in turn the loads on the rotor blade itself and on the wind turbine are increased.

It is therefore an object of the present invention to provide a rotor blade with a vibration-damping mechanism, and a method for manufacture of such a rotor blade.

The object is achieved in a first aspect by a rotor blade cited initially with the features of claim 1.

The invention is based on the concept of providing the principle of a particle damping device in a rotor blade which has at least one cavity with inner walls delimiting an interior, and with a medium arranged in the interior so as to be movable with respect to the inner walls.

The medium may comprise separate particles. In this connection, they are preferably balls which are movable individually.

The medium may however also comprise particles introduced into a highly viscous medium with a viscosity of for example 1 Pa s. Other media are also conceivable.

A cavity here means a void which is preferably completely surrounded by inner walls, or at least largely surrounded by inner walls. The inner walls may be closed or also sieve-like surfaces. The inner walls and the interior of the cavity are configured such that during operation, but also during stoppage of the rotor blade, the medium cannot flow or fall out of the cavity but remains permanently stored.

The vibration energy of the rotor blade is converted into heat by the particle damping device according to the invention. The conversion process is here called dissipation. Dissipation comprises both the conversion of vibration energy into thermal energy from movement of the particles in a highly viscous medium, and also the case of conversion of vibration energy of the rotor blade into heat from friction of the particles on the inner walls and/or by non-elastic impacts on the inner walls or on one another.

It has been found that the vibrations of the rotor blade can amount to up to 20% of the rotor blade length or even more.

In principle, the vibration frequency to be damped may be controlled by selection of the particles and the inner walls. Particles of different materials may also be used in order to damp a broad frequency band. Combinations of particle damping with highly viscous medium and without highly viscous medium are also conceivable.

Preferably, the particle damping device has a plurality of cavities each with an inner wall, each of which contains a medium which is arranged so as to be movable with respect to the inner wall.

The cavity or the plurality of cavities may be arranged at different locations on the rotor blade and be formed mutually differently. During rotation of the rotor blade, the particles are pressed against a radially outer inner wall of the cavity by the centrifugal force in the cavity, wherein the term “radial” relates to the radius of the circle described by the rotation of the rotor.

In one embodiment of the invention, the cavities extend along a width of the rotor blade from the leading edge to the trailing edge, and are preferably arranged next to one another along a thickness of the rotor blade. In the longitudinal direction, they may have a length from a few centimetres up to metres. They may preferably be arranged over a distance of two-thirds of the length of the rotor blade starting from the rotor blade root. The particles are freely movable in the cavity between the leading and trailing edge, and can particularly favourably dissipate vibration energy of vibrations in the edge direction. The particles absorb vibration energy by friction against the radially outer inner wall. Dissipation however also occurs from viscosity and mutual collision of the particles.

The cavities preferably extend over the entire thickness of the rotor blade so that on vibrations in the flap direction, i.e. along the thickness of the rotor blade, during operation friction occurs between the particles and the side inner walls which damps the vibration by dissipation.

In another embodiment of the invention, the cavities extend along a thickness of the rotor blade and are preferably arranged next to one another along the width of the rotor blade.

Again, they have a length in the longitudinal direction from a few centimetres up to tens of centimetres. This embodiment of the cavity is suitable in particular for particle damping in the flap direction, i.e. for damping vibrations which run to and fro between the suction and pressure side of the rotor blade.

Here too, in operation, the particles are pressed against the radially outer inner wall of each of the cavities, and on occurrence of flap vibrations, the particles again rub against the inner wall of the cavity and dissipate the flap vibration energy. The dissipation however also occurs through viscosity and collisions. Particularly preferably, the cavities may be arranged between two webs, in particular between two main webs. They may however also be arranged next to one another over the entire width of the rotor blade. Between the webs, the cavities may be oriented along the width or along the thickness. In other words, the cavity has a longest extent in the width direction or thickness of the rotor blade, so that the particles can oscillate particularly far along the longest extent. In the first case, they are intended for edge damping and in the second case, for flap damping.

In a particularly preferred embodiment of the invention, the plurality of cavities are arranged in a recurrent pattern, e.g. in the form of a honeycomb pattern, wherein the cavities are formed elongate and run along the thickness or width, and present said regular pattern, e.g. the honeycomb pattern, in a cross-section perpendicularly to the thickness or width.

Particularly preferably, a trimming mass of the rotor blade is configured as a medium. The trimming mass is preferably also arranged so as to be movable in the interior of the cavity. Normally, the rotor blades of a wind turbine do not have precisely the same weight after manufacture. In order to avoid imbalances during rotation of the rotor, the different weights are compensated by so-called trimming masses. For this, at specified locations within the rotor blade, cavities are provided in which the corresponding trimming mass is arranged.

According to the invention, the trimming mass is used as part of the particle damping device. The mass is not arranged in a fixed position and rigid in itself relative to the rotor blade, as in the conventional fashion, but as a movable medium which is arranged so as to be movable with respect to the inner walls of the cavity. Usually, trimming masses are provided on a web side facing another web, or between a web and a rotor blade trailing edge. However, other positions for trimming masses are also conceivable.

In a second aspect, the object is achieved by a method with the features of claim 11.

The method according to the invention for manufacture of a particle-damped rotor blade is suitable for manufacture of one of the above-mentioned rotor blades. Conversely, the above-mentioned rotor blades may be manufactured in one of the following methods.

According to the invention, an interior of the rotor blade is fitted with at least one cavity having inner walls delimiting an interior, and in the at least one cavity a medium is arranged which is movable with respect to the inner walls. The medium may, as stated, comprise separate particles or be a highly viscous medium containing particles. The particles may have the same or different sizes, and are preferably balls. Particularly preferably, a plurality of cavities are arranged in the interior of the rotor blade and each of the cavities is filled with the medium.

Favourably, the weights of particles of different rotor blades of a wind turbine are matched in their weights such that all rotor blades have the same weight.

Particularly preferably, a trimming mass of the rotor blade is determined and the trimming mass is configured as a medium which is used for the particle damping device.

The invention is described below with reference to four exemplary embodiments in thirteen figures. The drawings show:

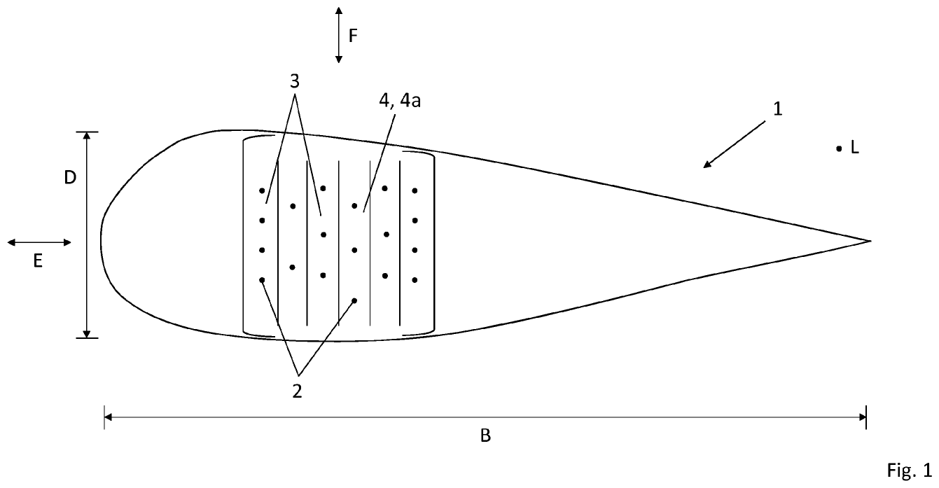

FIG. 1 a sectional view of a rotor blade according to the invention with a flap particle damping in a first embodiment,

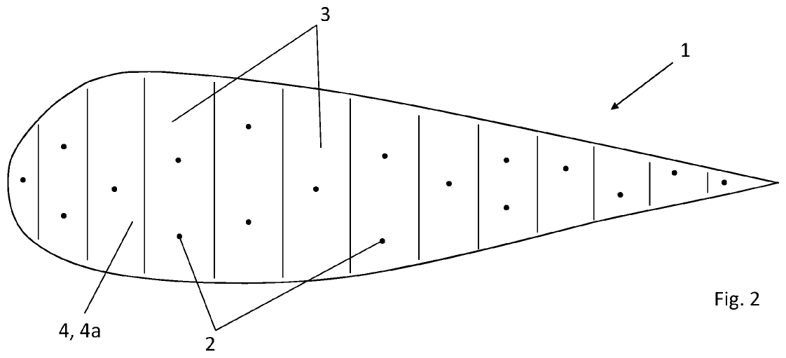

FIG. 2 a sectional view of a rotor blade according to the invention in a second embodiment with a flap particle damping,

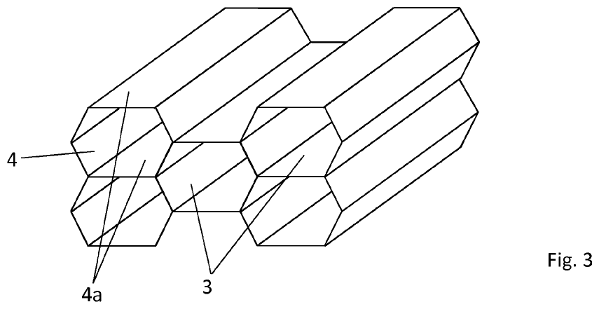

FIG. 3 a perspective view of the cavities used in FIG. 1 and FIG. 2 of a honeycomb arrangement,

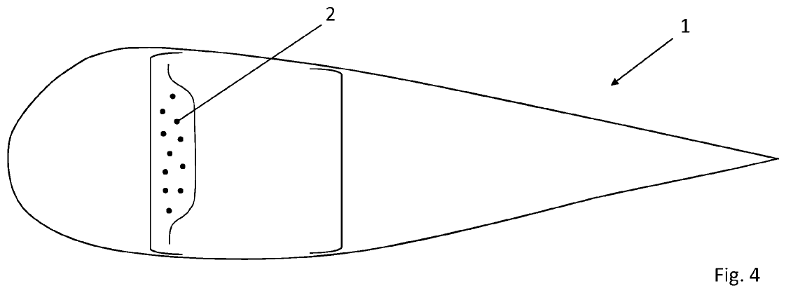

FIG. 4 a rotor blade according to the invention in a third embodiment with particles used as a trimming mass,

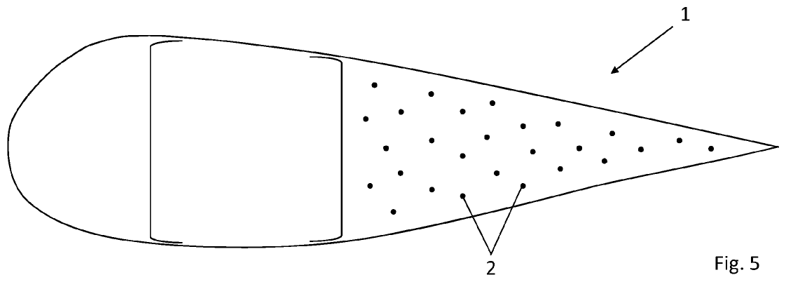

FIG. 5 a sectional view of a rotor blade according to the invention in a fourth embodiment, also with particles used as a trimming mass,

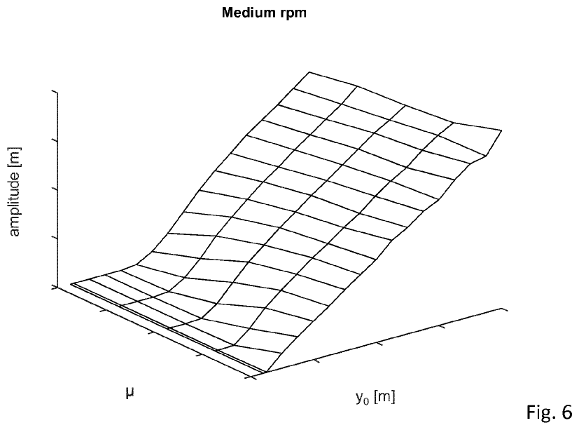

FIG. 6 a graphic illustration of a vibration amplitude of the particle depending on a coefficient of friction and a vibration amplitude of the rotor blade at a first rotation speed,

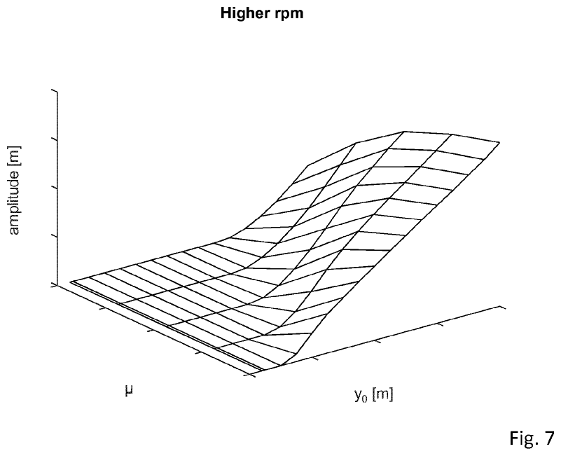

FIG. 7 a graphic illustration of a vibration amplitude of the particle depending on a coefficient of friction and a vibration amplitude of the rotor blade at a second rotation speed,

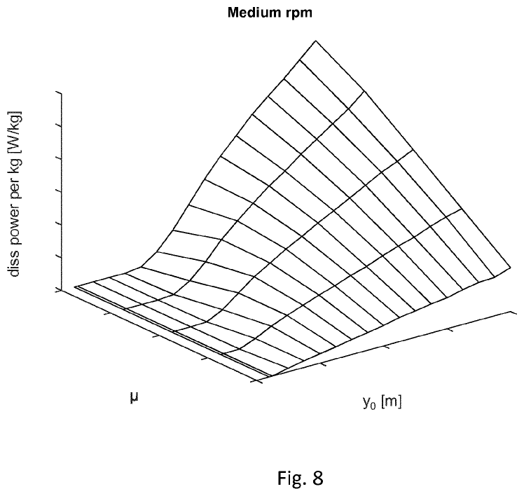

FIG. 8 a graphic illustration of a dissipated power per mass unit depending on a coefficient of friction and a vibration amplitude of the rotor blade at a first rotation speed,

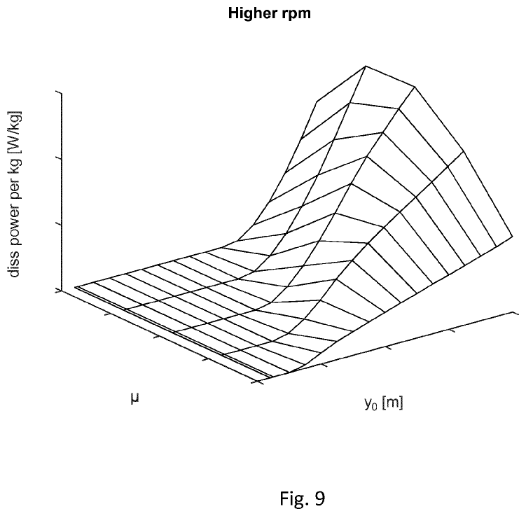

FIG. 9 a graphic illustration of a dissipated power per mass unit depending on a coefficient of friction and a vibration amplitude of the rotor blade at a second rotation speed,

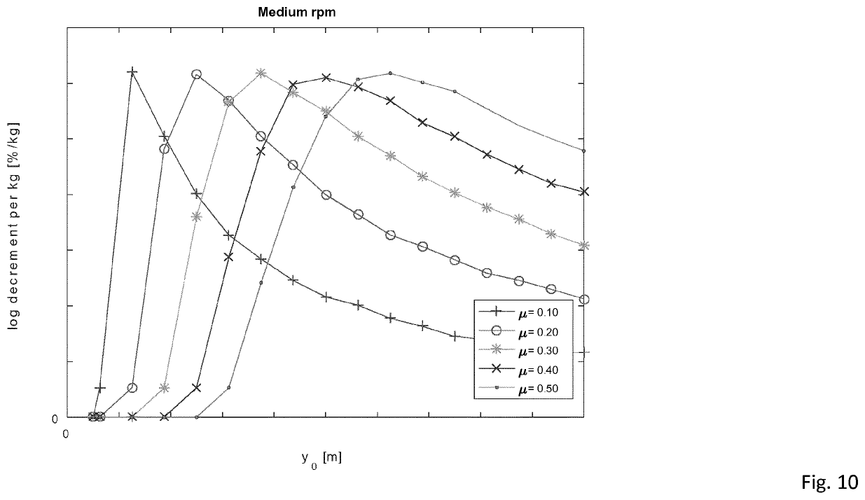

FIG. 10 an illustration of a damping δ over the amplitude y₀ for various coefficients of friction μ at a rotation speed of U-6.30 rpm,

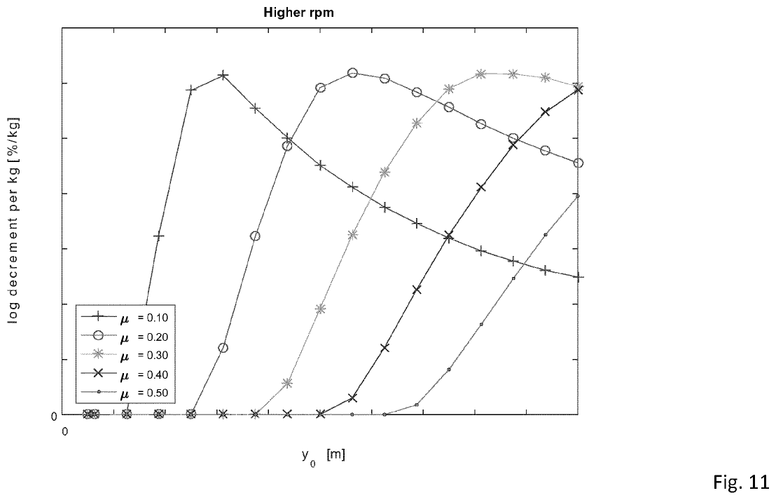

FIG. 11 an illustration of a damping δ over the amplitude y₀ for various coefficients of friction μ at a rotation speed of U-9.60 rpm,

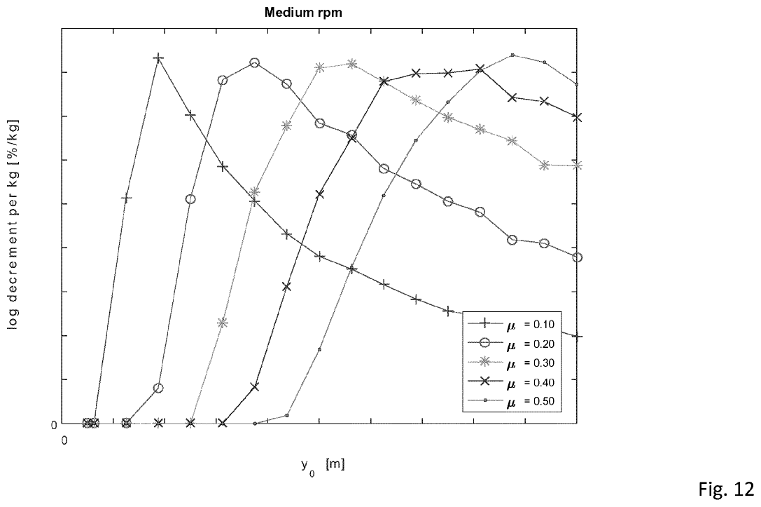

FIG. 12 an illustration of a damping δ over the amplitude y₀ for various coefficients of friction μ at a rotation speed of U-6.30 rpm,

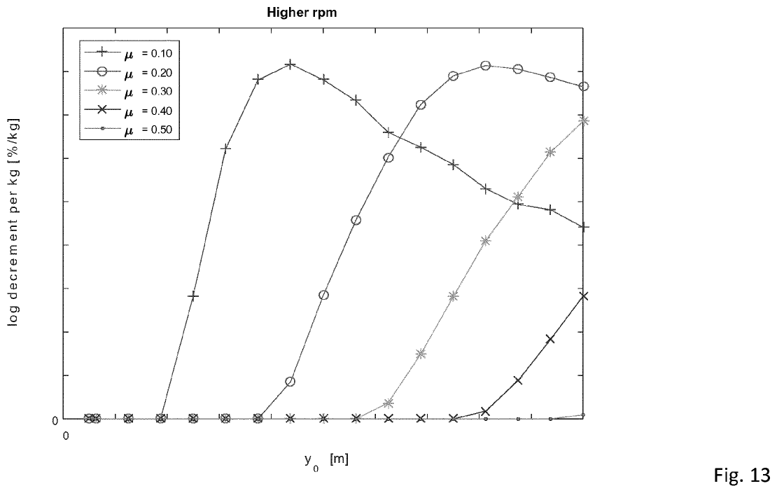

FIG. 13 an illustration of a damping δ over the amplitude y₀ for various coefficients of friction μ at a rotation speed of U-9.60 rpm.

In the damping of vibrations of a rotor blade 1, we distinguish between vibrations in a flap direction F which runs along a thickness D of the rotor blade 1, and vibrations in an edge direction E which runs along a width B of the rotor blade 1. The two vibration directions are shown in FIG. 1.

Vibrations in a longitudinal direction L of the rotor blade 1 are ignored here. Particle damping is based on the principle that particles 2 are arranged in a cavity 3 so as to be movable with respect to the inner walls 4 of the cavity 3. A cavity 3 is here a closed space of fundamentally arbitrary size and inner extent. The internal form of the cavity 3 may in principle be arbitrary in any cross-section.

The cavities 3 may be provided only between two main chords according to FIG. 1, or be arranged next to one another along the entire width B according to FIG. 2.

The plurality of cavities 3 are arranged in a recurrent pattern according to FIG. 3, e.g. in the form of a honeycomb pattern, wherein the cavities 3 are formed elongate and in each case run along the thickness D or width B, and present the regular pattern shown in FIG. 3, e.g. the honeycomb pattern, in a cross-section perpendicularly to the thickness D or width B.

According to FIGS. 4 and 5, a trimming mass of the rotor blade 1 is formed as a medium. The trimming mass is preferably also arranged so as to be movable in the interior of the cavity 3. In FIG. 4, the trimming mass is provided between the two main webs, and in FIG. 5 between the one main web and a rotor blade trailing edge.

At low rotation speeds, only a low centrifugal force forms in the cavity 3. The particles 2 move freely in the cavity 3 and vibration damping takes place in that the particles 2 hit the inner wall 4 and the other particles, and thus absorb the vibration energy of the rotor blade 1.

For the case that the rotation speed and hence a centrifugal force F_{c}=a_{c}*m increases, the particles 2 are pressed against the radially outer wall 4a of the cavity 3. There they become arranged next to one another and, due to the vibration of the rotor blades 1, slide to and fro on the radially outer wall 4a of the cavity 3. This creates friction which absorbs energy and damps the vibration. In the present case, primarily the second dissipation mechanism is concerned, i.e. the friction of the particles 2 on the inner wall 4 of the rotor blade 1.

For the sake of simplicity, as stated initially, the friction of the particles 2 on the inner wall 4 of the cavity 3 is regarded as the main contribution to the damping system in operation when the wind turbine is turning. The movement equation of the particle 2 is as follows:

m[ÿ(t)+\ddot{x}(t)]+μFₙ·sign(\dot{x}(t))=0.

Here, y is the deformation (vibration) of the rotor blade 1 at the position at which the system is arranged, and x is the relative position of the particle 2 in the rotor blade 1. This means that when the particle 2 also moves, i.e. for example if the coefficient of friction μ is high, the relative movement is x=0. This the coefficient of friction is low, i.e. the particle 2 does not move with the rotor blade 1 but remains stationary in space, then x=−y.

μ is the coefficient of friction, m the mass of the particle and Fₙ the normal force. The normal force is approximately

Fₙ=m·c_{c}=m·(ω²R±g)

The equation is thus independent of the mass.

It is assumed that the vibration of the blade is

y(t)=y₀·sin(2πfₑt)

wherein fₑ is the first natural frequency in the vibration direction (edge or flap). The graphs in FIG. 6 and FIG. 7 show that the amplitude of the particles 2 is small in the case of high friction and low amplitude of the rotor blade vibration; in other words, the particles 2 vibrate with the rotor blade 1. No dissipation by friction takes place here.

The conservative estimate performed by ourselves shows that the dissipation arises only from the friction between the particles 2 and the inner wall 4 of the cavity 3. In fact, there are further mechanisms such as the mutual impact between the particles 2, and the additional friction of the particles 2 in a viscous medium etc.

The dissipation energy per rotor revolution per unit mass is:

$$\frac{{E}_{d}}{m} = 4 {x}_{ampl} \cdot μ {a}_{c}$$

The dissipative power per mass unit is calculated as:

$$\frac{{W}_{d}}{m} = \frac{{E}_{d}}{m \cdot {f}_{e}} = \frac{4 {x}_{ampl} \cdot μ {a}_{c}}{{f}_{e}}$$

The results are shown in the graphs in FIGS. 8 and 9.

The vibration energy for the natural mode is:

$$U = \frac{1}{2} {( 2 π {f}_{e} )}^{2} {u}_{e}^{2} = \frac{1}{2} {( 2 π {f}_{e} )}^{2} {( \frac{{y}_{s y s}}{{q}_{e s y s}} )}^{2} ,$$

wherein yₜᵢₚ is the amplitude of the rotor blade vibration and qᵢ the amplitude of the natural mode, evaluated at the position of the damping system.

The damping factor may be defined as a logarithmic decrement

$$δ = ln \frac{y ( t )}{y ( t + T )}$$

wherein y is the amplitude of the rotor blade vibration and T the vibration duration.

The logarithmic decrement also amounts to:

$$δ = ln \sqrt{\frac{U}{U - {E}_{d}}} = \frac{1}{2} ln \frac{U}{U - {E}_{d}}$$

The graphs in FIG. 10 and FIG. 11 illustrate the damping δ with respect to the amplitude y₀ for various coefficients of friction μ and rotation speeds U. The damping δ is a measure of the ratio between the dissipative energy E_{d} of the particle damping mechanism and the quantity of energy contained in the rotor blade vibration. The graphs in FIG. 10 and FIG. 11 show the correlation for an arrangement of the particle damping mechanism which is provided over 100% of the length of the rotor blade 1. In the graphs in FIGS. 12 and 13, the particle damping mechanism is arranged over 80% of the length of the rotor blade 1.

According to the present results, a few kilogrammes of particles 2 may, depending on rotor blade type, achieve a doubling of the edge damping of the rotor blades.

### LIST OF REFERENCE SIGNS

1 Rotor blade
2 Particle
3 Cavity
4 Inner wall
4a Radially outer wall
B Width
D Thickness
E Edge direction
F Flap direction
L Longitudinal direction

1. Rotor blade of a wind turbine with at least one particle damping device having at least one cavity (3) with inner walls (4) delimiting an interior, and with a medium arranged in the interior so as to be movable with respect to the inner walls (4).

2. Rotor blade according to claim 1, characterised in that the particle damping device has a plurality of cavities (3) each with an inner wall (4), each of which contains the medium which is arranged movably with respect to the inner wall (4) in each case.

3. Rotor blade according to claim 1, characterised in that the medium comprises separate particles (2).

4. Rotor blade according to claim 3, characterised in that the particles (2) are balls.

5. Rotor blade according to claim 1, characterised in that the particles (2) are arranged in a viscous fluid.

6. Rotor blade according to claim 1, characterised in that the cavities (3) extend along a width (B) of the rotor blade (1) and are arranged next to one another along a thickness of the rotor blade.

7. Rotor blade according to claim 1, characterised in that the cavities (3) extend along a thickness (D) of the rotor blade (1) and are arranged next to one another along the width of the rotor blade.

8. Rotor blade according to claim 1, characterised in that the plurality of cavities (3) are arranged between webs.

9. Rotor blade according to claim 1, characterised in that the plurality of cavities (3) in cross-section have a recurrent pattern, in particular a honeycomb structure.

10. Rotor blade according to claim 1, characterised in that a trimming mass has particles (2) which are arranged so as to be movable in the cavity (3).

11. Method for manufacture of a particle-damped rotor blade (1), by an interior of the rotor blade (1) being fitted with at least one cavity (3) having inner walls (4) delimiting the interior, a medium which is movable with respect to the inner walls (4) being filled in the at least one cavity (3).

12. Method according to claim 11, characterised in that separate particles (2) are used as the medium.

13. Method according to claim 9, characterised in that a plurality of cavities (3) are arranged in the interior and each of the cavities (3) is filled with the medium.

14. Method according to claim 9, characterised in that the weights of particles (2) of different rotor blades (1) of a wind turbine are matched in their weights such that all rotor blades (1) have the same weight.

15. Method according to claim 11, characterised in that a trimming mass is determined and used as particles (2) of the particle damping device.
